(19) United States
(12) Patent Application Publication
(10) Pub. No.: US 2009/0237656 A1
(43) Pub. Date: Sep. 24, 2009

(54) Tomographic Imaging Using Hyperspectral Absorption Spectroscopy

(76) Inventor: Lin Ma, Clemson, SC (US)

Correspondence Address: Ballard Spahr Andrews & Ingersoll, LLP, SUITE 1000, 999 PEACHTREE STREET, ATLANTA, GA, 30309-3915, US

(21) Appl. No.: 12/393,845

(22) Filed: Feb. 26, 2009

Related U.S. Application Data
(60) Provisional application No. 61/033,972, filed on Mar. 5, 2008.

(51) Int. Cl. G01J 3/00; G01J 3/28

(52) U.S. Cl. 356/300; 356/328

(57) ABSTRACT

Described herein are systems and methods of tomographic imaging using hyperspectral absorption spectroscopy, which may comprise simultaneously performing absorption measurements at multiple different wavelengths and then performing a tomographic inversion process to exploit the hyperspectral absorption spectroscopy information obtained. The methods and systems described herein can be used to a) exploit the hyperspectral information content to reduce the number of projections required and to improve the stability of the tomographic reconstruction in the presence of measurement errors, b) enable flexible incorporation of various a priori information, c) ameliorate the ill-posedness of the tomographic inversion problem. These advantages are useful in the practical application of tomographic techniques.

### CROSS-REFERENCE TO RELATED PATENT APPLICATIONS

This application claims priority to, and incorporates by reference, U.S. Application Ser. No. 61/033,972 entitled “Tomographic Imaging Using Mutli-Spectral Absorption Spectroscopy” filed on Mar. 5, 2008.

### BACKGROUND

Tomographic imaging is a highly developed technique in many disciplines; medicine, geophysics, archaeology, to name a few. In these applications, a large number (usually tens of thousands) of projection measurements are collected to reconstruct an image. However, in many other applications, only a small number of projections (e.g., less than fifty) are available due to the rapid dynamics of the phenomena under investigation and the practical complexity and cost to obtain many projections. A notable example involves the tomographic imaging of gas properties (e.g., temperature and concentration of gaseous species) in reactive flows, including for example plasmas, laboratory flames, production engines, and industrial incinerators.

The primary cause of the requirement for a large number of projections is that past research efforts generally relied on only one or two wavelengths. As a result of the limited spectral information content, a satisfactory reconstruction can require a large number of projections (e.g., on the order of 100) distributed over several viewing angles. Such a requirement can create significant implementation difficulty in practice. To circumvent the implementation difficulty, applications of the previous absorption-based tomographic techniques are often limited to three scenarios: a) simple flow geometries (such as one-dimensional flows, b) situations where temperature variation can be neglected or otherwise obtained (via computation or other measurements method), and c) situations where a large amount of a priori information is available such that the tomographic reconstruction can be conducted based on basis functions.

A need, therefore, exists for systems and methods of using tomographic imaging in applications where only a small number of projections are available or desirable.

### SUMMARY

Described herein are systems and methods for the use of hyperspectral (also referred to as multi-spectral) absorption spectroscopy in tomographic techniques to overcome limitations found in the art. In particular, according to embodiments described herein, multiple wavelengths can be used in the tomography scheme to increase the spectral information content, and the increased spectral information can be used to reduce the number of projections needed. A tomographic inversion process can then be performed in order to exploit the hyperspectral absorption spectroscopy information obtained and create a tomographic image of one or more properties (e.g., temperature, concentration, etc.) of a given substance (e.g., a gas).

Reference is made throughout to “hyperspectral” absorption. However, while it is often customary in the optics and spectroscopy community to use the term “hyperspectral” when a large number of wavelengths is involved, the terms “multi-spectral” and “hyperspectral” may be used interchangeably when referring to embodiments described herein.

According to one aspect a method is provided that may include performing tomographic imaging of one or more properties of a substance using hyperspectral absorption spectroscopy. According to one embodiment, performing the tomographic imaging may include simultaneously capturing, by one or more tomographic imaging devices, an absorption measurement of the substance at three or more wavelengths, and then using, by a computing device, the captured absorption measurements to create a tomographic image of the one or more properties of the substance.

In one embodiment, using the captured absorption measurements to create a tomographic image may include performing, by the computing device, a tomographic inversion process configured to exploit the hyperspectral absorption spectroscopy information obtained from the absorption measurements captured. This may further include, for example, formulating the hyperspectral absorption spectroscopy information into a tomographic problem, casting the tomographic problem into a minimization problem configured to minimize the difference between one or more computed projections and one or more measured projections, and solving the minimization problem by an algorithm.

According to another aspect a system is provided for performing tomographic imaging of one or more properties of a substance using hyperspectral absorption spectroscopy. In one embodiment, the system may include one or more tomographic imaging devices configured to simultaneously capture an absorption measurement of the substance at three or more wavelengths, and a computing device configured to receive the captured absorption measurements and to create the tomographic image of the one or more properties of the substance.

In another embodiment, respective tomographic imaging devices may be positioned at a different location with respect to the substance, such that the one or more tomographic imaging devices are further configured to simultaneously capture an absorption measurement of the substance at three or more wavelengths at each of the one or more different locations.

In accordance with yet another aspect a computer program product is provided. The computer program product may include at least one computer-readable storage medium having computer-readable program code portions stored therein. In one embodiment, the computer-readable program code portions may include a first executable portion for performing tomographic imaging of one or more properties of a substance using hyperspectral absorption spectroscopy.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 provides an illustrative definition of the coordinate system and the discretization configuration of embodiments described herein;

FIG. 2 is an exemplary block diagram illustrating an embodiment of an inversion algorithm for hyperspectral tomography;

FIGS. 3A & 3B illustrate temperature (3A) and concentration (3B) phantoms used in an exemplary embodiment described herein;

FIG. 4 illustrates evolution of the value of F, and the solution errors in temperature (T) and concentration (X) during the minimization using the simulated annealing (SA) algorithm of embodiments described herein;

FIGS. 5A & 5B illustrate reconstructed T and X profiles in accordance with embodiments described herein;

FIGS. 5C & 5D illustrate reconstruction error defined as the difference between the reconstructions and the phantoms in accordance with embodiments described herein;

FIG. 6 illustrates a comparison between the reconstructions and the phantoms along the fourth column of the grid without and with uncertainties in the projections in accordance with embodiments described herein;

FIG. 7 illustrates a comparison of the reconstruction quality between the HT technique and a two-wavelength tomographic scheme at different noise levels in the projections in accordance with embodiments described herein;

FIGS. 8A-8D provide reconstructions from the hyperspectral tomographic (HT) technique and a two-wavelength tomography scheme, respectively, in accordance with embodiments described herein;

FIG. 9 illustrates normalized mean absolute distance measure (e_{T}) of T reconstruction at different combinations of γ_{T} and γ_{X} in accordance with embodiments described herein;

FIG. 10 illustrates the contribution from D and the regularization factor to the master function, F, at different values of γ_{T}, with γ_{X}=1×10⁸γ_{T} in accordance with embodiments described herein;

FIG. 11 illustrates the contribution from D and the regularization factor to the master function, F, at different values of γ_{T}, with γ_{X}=0 in accordance with embodiments described herein;

FIG. 12 is an exemplary block diagram summarizing an embodiment of a method of determining of the optimal regularization parameters in the HT technique;

FIG. 13 illustrates a plot of the residual versus the regularization factor with g ranging from 10⁻⁹ to 10³ in accordance with embodiments described herein;

FIG. 14 shows the values of e_{X} at different values of g in accordance with embodiments described herein;

FIG. 15 shows the values of e_{X} at different combinations of γ_{T} and γ_{X} in accordance with embodiments described herein;

FIG. 16A is a block diagram of one type of system that may benefit from the hyperspectral tomographic imaging techniques of embodiments described herein;

FIG. 16B is a block diagram of a computing device configured to perform aspects of the hyperspectral tomographic imaging techniques of embodiments described herein; and

FIG. 17 illustrates monitoring a combustion device using an embodiment of the systems and methods of tomographic imaging using hyperspectral absorption spectroscopy described herein.

### DETAILED DESCRIPTION

Before the present methods and systems are disclosed and described, it is to be understood that the methods and systems are not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

### Overview:

Embodiments described herein provide a technique for using hyperspectral absorption in connection with tomographic imaging in order to reduce the number of projections needed in order to obtain sufficient spectral information to create valuable tomographic images. In particular, advancements in laser sources and related wavelength-multiplexing technologies, which have made it feasible to obtain absorption information over a wide spectral range rapidly, have made it practically easier and less costly to incorporate one or more additional wavelengths in the tomographic scheme rather than to add an additional projection location and/or projection angle.

However, utilization of such a hyperspectral tomography (HT) technique can lead to a set of nonlinear equations because of the nonlinear dependence of absorption strength on temperature. Unfortunately, the limited availability of projection measurements can cause the problem to be ill-posed; thus resulting in a system of nonlinear equations that is difficult to solve. Accordingly, embodiments described herein further provide tomographic inversion methods that can exploit the hyperspectral information content. In one aspect, methods described herein enable simultaneous imaging of temperature and concentration distribution of chemical species, with the number of projections reduced to a level suitable for expanded usage in research and industrial applications thereby enhancing the practicality of hyperspectral tomography.

In another aspect, a method based on simulated annealing is provided that obtains tomographic reconstructions based on hyperspectral absorption spectroscopy. This method exploits spectral information content, incorporates various a priori information, and ameliorates the ill-posedness of the tomographic inversion problem. One application of the methods described herein can be for simultaneous temperature and chemical species concentration imaging, though other uses and applications are considered within the scope of the embodiments described herein.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### Introduction

Embodiments described herein provide systems and methods for the use of hyperspectral absorption spectroscopy in tomographic imaging for including multiple wavelengths in the tomography scheme to increase the spectral information content, and to use the increased spectral information to reduce the number of projections by employing tomographic inversion techniques that exploit the hyperspectral information content.

Along a uniform-property path, laser radiation absorbed across an absorption transition can be described by the following Beer-Lambert relationship:

$$\begin{matrix}{A}_{i} = {\int }_{- ∞}^{+ ∞} - ln \frac{{I}_{t} ( λ )}{{I}_{0} ( λ )} d λ \\ = P \cdot X \cdot L \cdot S ( T , {λ}_{i} )\end{matrix} \qquad ( 1 )$$

where Aᵢ is the integrated absorbance across the transition centered at wavelength λᵢ; Iₜ(λ) and I₀(λ) the intensity of the incident and transmitted laser beam at wavelength λᵢ, respectively; P the pressure; X the mole fraction (concentration) of the absorbing specie; L the absorption path length; and S(T, λᵢ) the absorption line strength at wavelength λᵢ and temperature T. The line strength as a function of temperature for a particular transition centered at λᵢ is governed by the following equation:

$$S ( T , {λ}_{i} ) = S ( {T}_{0} , {λ}_{i} ) \cdot \frac{Q ( T )}{Q ( {T}_{0} )} \cdot exp [ - \frac{{hcE}^{″}}{k} \cdot ( \frac{1}{T} - \frac{1}{{T}_{0}} ) ] \cdot \frac{1 - exp ( - \frac{{hc}^{2}}{kT {λ}_{i}} )}{1 - exp ( - \frac{{hc}^{2}}{{kT}_{0} {λ}_{i}} )} \qquad ( 2 )$$

where T₀ is the reference temperature, Q the absorber's partition function, h the Planck constant, c the speed of light, k the Boltzmann constant, and E″ the lower-state energy of the transition. Based on Equations (1) and (2), mole fraction and temperature of the absorbing species can be simultaneously determined by measuring a pair of its absorption transitions, as detailed in M. P. Arroyo, and R. K. Hanson, “Absorption-measurements of water-vapor concentration, temperature, and line-shape parameters using a tunable InGaAsP diode-laser,” App. Opt. 32, 6104-6116 (1993), incorporated herein by reference and made a part hereof.

When the absorber's properties (temperature and/or mole fraction) are not uniform along the path, Equation (1) can be modified to:

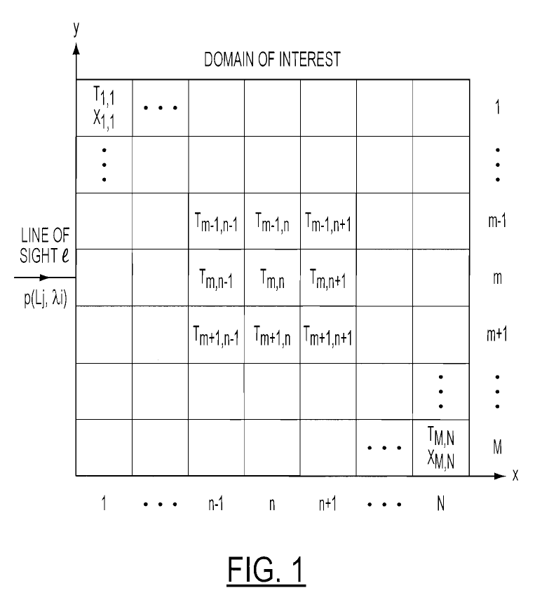

Aᵢ=P∫ₐ^{b}X(l)·S[T(l),λᵢ]dl (3)

where the pressure, P, is assumed to be uniform along the path; l is the coordinate along the line-of-sight as shown in FIG. 1; and a and b are the integral limits determined by the line-of-sight and the domain of interest as shown in FIG. 1. In a two-dimensional (2-D) tomography measurement, X and T are functions of spatial coordinates x and y in a certain domain of interest, as shown in FIG. 1. Line-of-sight absorption measurements can be performed at different locations (denoted by Lⱼ's, where j=1, 2, . . . , J, with J being the total number of projection locations) and different wavelengths (denoted by λᵢ's, where i=1, 2, . . . , I, with I being the total number of wavelengths); and such a measurement can be defined as a projection, denoted by p(Lⱼ, λᵢ) to emphasize its dependence on the projection location and the wavelength used. Based on Equation (3), projection at a location Lⱼ and a wavelength λᵢ can be calculated as:

p(Lⱼ,λᵢ)=P∫ₐ^{b}S[T(x,y),λᵢ]·X(x,y)·dl (4)

where T(x, y) and X(x, y) emphasize the 2-D variation of the temperature and mole fraction of the absorbing specie, and the integration is performed along the line-of-sight. Equation (4) essentially performs a forward Radon transform, as known to one of ordinary skill in the art, of the integrated absorbance along the projection location defined by l. It is to be appreciated that the hyperspectral tomography (HT) problem can be mathematically formulated as to determine T(x, y) and X(x, y) given a finite number of projections defined by Equation (4).

The T and X profiles can be discretized by superimposing a square mesh (of the size of M by N) over the domain of interest as shown in FIG. 1, with T_{m,n} and X_{m,n} representing, respectively, the value of the temperature and concentration of the grid on the m^{th} row and n^{th} column. The computation of the projection and the tomographic reconstruction can be conducted over these discrete values of T and X. Consequently, the MT problem becomes solving a system of nonlinear equations. Assuming a total of I wavelengths (i=1, 2, . . . , I) are used in the MT scheme, then the system contains a total of J×I equations (one equation at each projection location and each wavelength) and a total of 2×M×N unknowns (M×N unknown temperatures and M×N unknown concentrations). Each equation in the system is in the format of Equation (4).

In practice, the number of projection locations and wavelengths is limited, and is often desired to be minimized. Also, T and X are often subject to some a priori constraints, such as being smooth, non-negative, and bounded. Now, the hyperspectral tomographic problem can be mathematically formulated as: Given a finite number of projections defined by Equation (4), determine T(x, y) and X(x, y) subject to the a priori constraints.

When two wavelengths are used (i=1 and 2), the problem reduces to a standard inverse Radon transform, as discussed in detail in M. Ravichandran, and F. C. Gouldin, “Retrieval of asymmetric temperature and concentration profiles from a limited number of absorption measurements,” Comb. Sc. and Tech. 60, 231-248 (1988). Distribution of the integrated absorbance at each wavelength can be obtained via a suitable inverse Radon algorithm. Then, the distributions of the integrated absorbance at both wavelengths can be combined to solve for temperature and species concentration over each grid using the technique for uniform distributions. However, when an increased number of wavelengths are utilized, the HT problem fundamentally differs from past studies due to the availability of absorption information at multiple wavelengths. Results from past studies cannot be applied directly to incorporate such hyperspectral information. Therefore, embodiments of an inversion method are described herein to exploit the increased spectral information content.

According to one embodiment, in order to incorporate the hyperspectral information, the tomographic inversion can be cast into a minimization problem, in which T and X profiles are sought to minimize the difference between the projections computed based on them and the measured projections. More specifically, the difference can be defined by the following equation:

$$D ( {T}^{rec} , {X}^{rec} ) = {\sum }_{j = 1}^{J} {\sum }_{i = 1}^{I} \frac{{[ \begin{matrix}{p}_{m} ( {L}_{j} , {λ}_{i} ) - \\ {p}_{c} ( {L}_{j} , {λ}_{i} )\end{matrix} ]}^{2}}{{{p}_{m} ( {L}_{j} , {λ}_{i} )}^{2}} \qquad ( 5 )$$

where pₘ(Lⱼ, λᵢ) denotes the measured projection at a location Lⱼ and a wavelength λᵢ; p_{c}(Lⱼ, λᵢ) the computed projection based on a reconstructed T and X profile (denoted by T^{rec} and X^{rec}, respectively); and J and I the total number of wavelengths and projection locations used in the tomography scheme. The contribution from each projection to D is normalized by the projection itself, such that all projection measurements are weighted equally in the inversion. This difference, D, provides a quantitative measure of the closeness between the reconstructed and the actual temperature and concentration profiles. When T^{rec} and X^{rec} match the actual profiles, D reaches its global minimum (zero). However, it is a nonlinear optimization problem due to nonlinear temperature-dependence as described in Equation (2); and, therefore, is inherently ill-posed, i.e., the existence, uniqueness, and stability of the solution are not simultaneously ensured. Certain regularization techniques may be necessary to ameliorate the ill-posedness of the problem. For example, where T and X are in the context of sensing in gas flows they may be quite smooth due to strong diffusion and mixing. Therefore, smoothness regularization can be applied, characterized by means of the discrepancy between the value of each image grid and its nearest neighbors, i.e., by defining the following regularization factor:

$${R}_{T} ( T ) = {\sum }_{m = 1}^{M} {\sum }_{n = 1}^{N} {[ {T}_{m , n} - \frac{1}{8} ( \begin{matrix}\begin{matrix}\begin{matrix}{T}_{m - 1 , n - 1} + {T}_{m - 1 , n} + \\ {T}_{m - 1 , n + 1} + {T}_{m , n - 1} +\end{matrix} \\ {T}_{m , n + 1} + {T}_{m + 1 , n - 1} +\end{matrix} \\ {T}_{m + 1 , n} + {T}_{m + 1 , n + 1}\end{matrix} ) ]}^{2} \qquad ( 6 )$$

As shown, R_{T} reaches its minimum (zero) with a uniform temperature across the grid (the smoothest distribution); and R_{T} increases when the variations in temperature increases. A similar regularization factor, R_{X}, can be constructed to characterize the smoothness of a concentration distribution. To incorporate the smoothness constraints in the tomographic reconstruction, regularization factors can be added to the difference defined in Equation (5) to form a master function F, as defined below:

F(T^{rec},X^{rec})=D(T^{rec},X^{rec})+γ_{T}·R_{T}(T^{rec})+γ_{X}·R_{X}(X^{rec}) (7)

where γ_{T} and γ_{X} are positive constants (regularization parameters) to scale the magnitude of R_{T} and R_{X} properly such that they do not dominate the D(T^{rec}, X^{rec}) term. Minimization of F(T^{rec}, X^{rec}) with respect to T^{rec} and X^{rec} takes into consideration both the measurements and the a priori information. Physically, the magnitudes of γ_{T} and γ_{X} reflect the relative weights of a priori information (e.g. smoothness) and a posteriori knowledge (i.e., measurements) in the tomographic inversion process. Due to the nonlinear nature of the problem, the selection of the optimal γ_{T} and γ_{X} can be quite involved, and described further herein in relation to determination of optimal regularization parameters. Other types of regularizations, e.g. boundary conditions and/or partial differential equations that the distributions satisfy, can be constructed and incorporated into the inversion similarly.

By study of a variety of T and X distributions commonly encountered in practice with the above smoothness regularization incorporated, it was found that the minimization of F yields a unique and stable solution of T and X. Therefore, minimization of the master function, F, defined in Equation (7), can provide at least a practical way of solving the HT problem. This approach addresses the utilization of hyperspectral information as projection measurements at all wavelengths are used in the reconstruction. And, it offers the flexibility of incorporating a priori information of the profiles to be sought via regularization techniques.

### Minimization Algorithm

Minimizing the nonlinear function, F, defined above, can include consideration of the dimension of the problem and the existence of a great many multiple local minima. For example, for a 10×10 discretization, there are 200 variables in F (100 unknown T values and 100 unknown X values), and the number of variables increases with the degree of discretization. The function, F, exhibits a great many of local minima for a 10×10 discretization and the number of local minima also increases rapidly with the degree of discretization. These characteristics of F pose significant challenges to minimization algorithms using the derivative information, because these algorithms will be trapped in one of the local minima and thusly unable to provide the correct reconstruction of T and X. In various aspects, algorithms that do not depend on derivative information (e.g. the downhill simplex method and the adaptive random search method) can be used, but generally do not yield satisfactory results. However, the simulated annealing (SA) algorithm described in A. Corana, M. Marchesi, C. Martini, and S. Ridella, “Minimizing multimodal functions of continuous-variables with the simulated annealing algorithm,” ACM Trans. on Math. Soft. 13, 262-280 (1987), incorporated herein by reference and made a part hereof, provides for determining the T distribution by minimizing F, and accurate T distribution can be reconstructed even though the quality of the X reconstruction is poor.

The performance of the SA algorithm comes at a price of significantly increased computational cost of the SA algorithm compared to other algorithms (e.g. the downhill simplex and adaptive random search). To remedy the high computational cost, in one embodiment the SA algorithm can be combined with the Levenberg-Marquardt method, a local minimization algorithm that uses derivative information. In this hybrid algorithm, the SA algorithm first locates the region where the global minimum is most likely to occur, and then the Levenberg-Marquardt refines the solution. The reconstruction of an accurate T distribution even though the quality of the X reconstruction is poor is because the problem is nonlinear in T and linear in X, resulting in a more sensitive response of F with respect to T than to X. To address this issue, according to one embodiment, the T and X distributions can be solved in two steps. In the first step, the T distribution can be reconstructed via minimizing F using the hybrid algorithm. Then the reconstructed T distribution can be used to calculate the absorption strength at each wavelength over each grid, and the problem becomes a linear problem with respect to X, which can be written in the following matrix format:

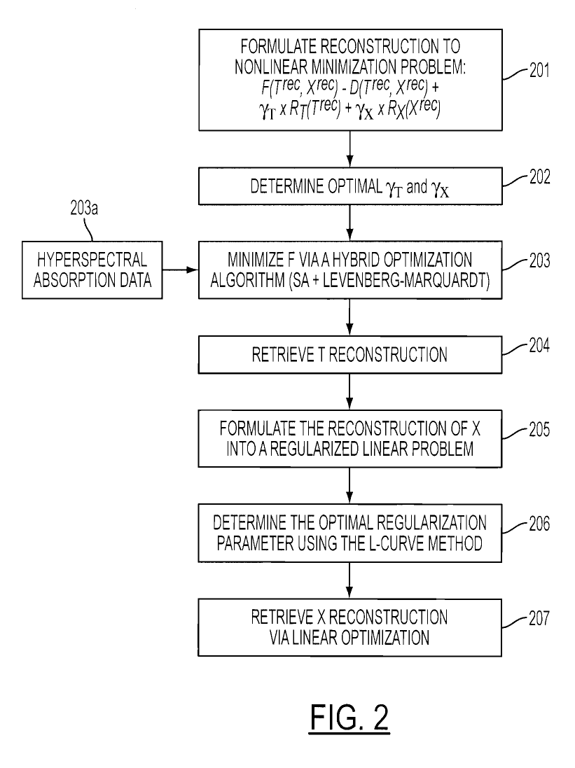

\vec{p}ₘ=\vec{S}[T^{rec}(x,y),λ]·\vec{X} (8)

where \vec{p}ₘ represents the measured projections organized to a column vector; \vec{X} the concentration values organized to a column vector; and \vec{S} the corresponding absorption strength matrix evaluated at the wavelengths used (denoted by λ) and the T distribution obtained in the first step (denoted by T^{rec}(x, y)). In the second step, Equation (8) can be solved in a least squares sense to yield X with a regularization technique. Detailed discussion of this method is described below in relation to determination of optimal regularization parameters. This two-step reconstruction method is summarized and illustrated in the block diagram shown in FIG. 2.

In particular, as described in more detail herein, according to one embodiment, the process can begin at Block 201, by formulating the master function F, as defined above in Equation (7). Once formulated, optimal values for regulation parameters γ_{T} and γ_{X} (discussed below) can be determined, at Block 202. The master function F can then be minimized, at Block 203, using, for example, the SA algorithm combined with the Levenberg-Marquardt method, as well as hyperspectral absorption data provided at Block 203a.

T and X distributions can then be solved in two overall steps. In particular, the T distribution can be reconstructed via minimizing F (at Block 204), and the reconstructed T distribution can be used to formulate the reconstructions of X into a regularized linear problem (at Block 205). As described in more detail below, optimal regularization parameters γ_{T} and γ_{X} can be determined in the first and second steps, for example, using the L-curve method (at Block 206), and, finally, the X reconstruction can be retrieved via optimization of the regularized linear problem (at Block 207).

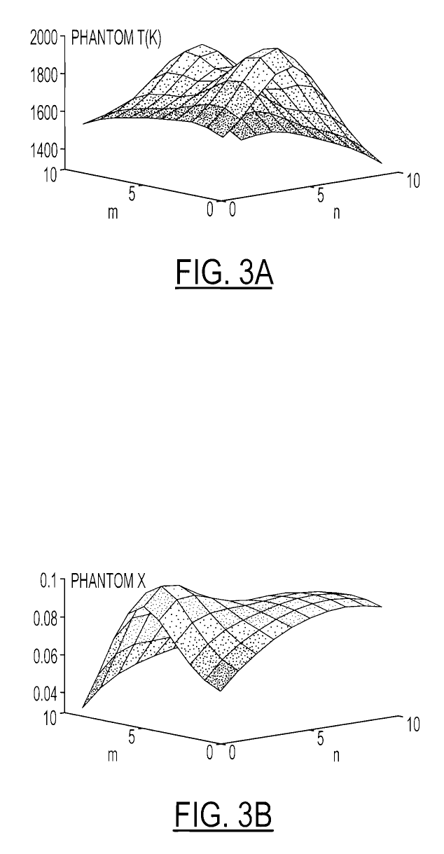

An example in which the minimization process is monitored is provided herein. In this example, the T and X distribution phantoms depicted in FIGS. 3A and 3B, respectively, are used. These distribution phantoms can be created by superimposing two Gaussian peaks on a paraboloid to simulate the multi-modal and asymmetric temperature distribution encountered in, for example, practical combustion devices. The dimension of the grid is 10×10 (M=10 and N=10), though it is to be appreciated that other distribution phantoms can be used. This example uses a total of 20 projection locations (J=20, 10 horizontal and 10 vertical) and 10 wavelengths at each location (I=10). These wavelengths are taken from X. Zhou, X. Liu, J. B. Jeffries, and R. K. Hanson, “Development of a sensor for temperature and water concentration in combustion gases using a single tunable diode laser,” Meas. Sc. & Tech. 14, 1459-1468 (2003), incorporated herein by reference, corresponding to selected absorption transitions of water vapor near 1.8 μm. These transitions may be recommended for line-of-sight-averaged combustion measurements based on the absorption of water vapor due to their strong absorption strengths to maximize signal level, and their relative isolation from neighboring absorption transitions to minimize interference. Note that these wavelengths are exemplary and used here only for the purpose of evaluating and demonstrating the algorithm. In practice, the specification of the laser source (e.g. scan range and performance in different spectral ranges) may also need to be considered in the selection of the wavelengths. Application of the inversion algorithm to the design of a practical hyperspectral tomography sensor is underway.

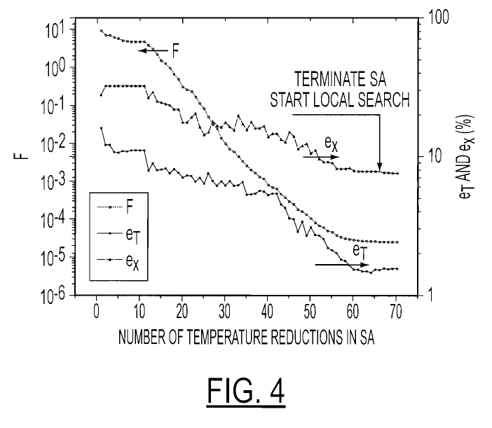

With the settings described above, a master function, F, can be constructed, and the minimization process of F is shown in FIG. 4, wherein a γ_{T} of 1×10⁻¹⁰ and γ_{X} of 1×10⁻²⁰ are used. Here, the change of the value of F and the closeness of the T and X distributions to the phantoms during the SA algorithm is monitored. The closeness can be quantified by the following normalized mean absolute distance measures:

$$\begin{matrix}{e}_{T} = \frac{{\sum }_{m = 1}^{M} {\sum }_{n = 1}^{N} \vert {T}_{m , n}^{rec} - {T}_{m , n} \vert}{{\sum }_{m = 1}^{M} {\sum }_{n = 1}^{N} \vert {T}_{m , n} \vert} & ( 9 ) \\ {e}_{X} = \frac{{\sum }_{m = 1}^{M} {\sum }_{n = 1}^{N} \vert {X}_{m , n}^{rec} - {X}_{m , n} \vert}{{\sum }_{m = 1}^{M} {\sum }_{n = 1}^{N} \vert {X}_{m , n} \vert} & ( 10 )\end{matrix}$$

These two quantities, e_{T} and e_{X}, provide a measure of the average deviation of T^{rec} and X^{rec} to the phantoms. The SA algorithm started with an initial guess of a uniform T and X distribution, and reduced the value of F steadily at each “temperature reduction,” a terminology used in the SA algorithm derived from the algorithm's analogy with the way liquids crystallize and metals anneal. However, e_{T} and e_{X} do not decrease monotonically with decreasing F, resulting from the stochastic nature of the algorithm and the existence of multiple local minima of F. With the reduction of the temperature in the algorithm, the fluctuations in e_{T} and e_{X} are gradually damped out, indicating that the algorithm has located the region where the global minimum of F occurs. After this region has been identified, a more computationally efficient algorithm (e.g., the Levenberg-Marquardt algorithm) can be used to refine the solution. In the method of embodiments described herein, the SA algorithm can be terminated when the largest change in T is less 0.1 K, corresponding to 66 temperature reductions in this example as shown in FIG. 4. Also, note that at the end of the SA algorithm, an e_{T} of 1.50% can be obtained while the e_{X} is still quite large (7.23%), illustrating the sensitive response of F to T due to the nonlinear dependence on T, as mentioned previously. The Levenberg-Marquardt algorithm can then continue the minimization and refine the solution to the desired accuracy (a relative change in F less than 1×10⁻⁸). In this example, the Levenberg-Marquardt algorithm finally reduces e_{T} and e_{X} to 1.44% and 5.25%, respectively, and completes the first step. The T reconstruction obtained can be used in the second step to evaluate the \vec{S} matrix described in Equation (8) to solve for the X distribution. An e_{X} of 4.87% is obtained at the end of the second step in this example, and completing the entire reconstruction process.

### Simulation Results

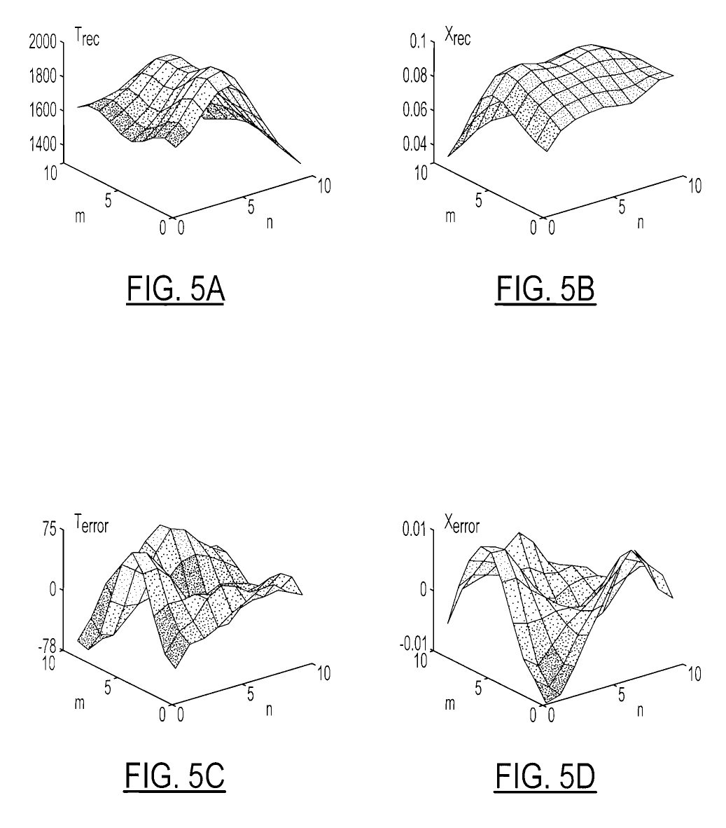

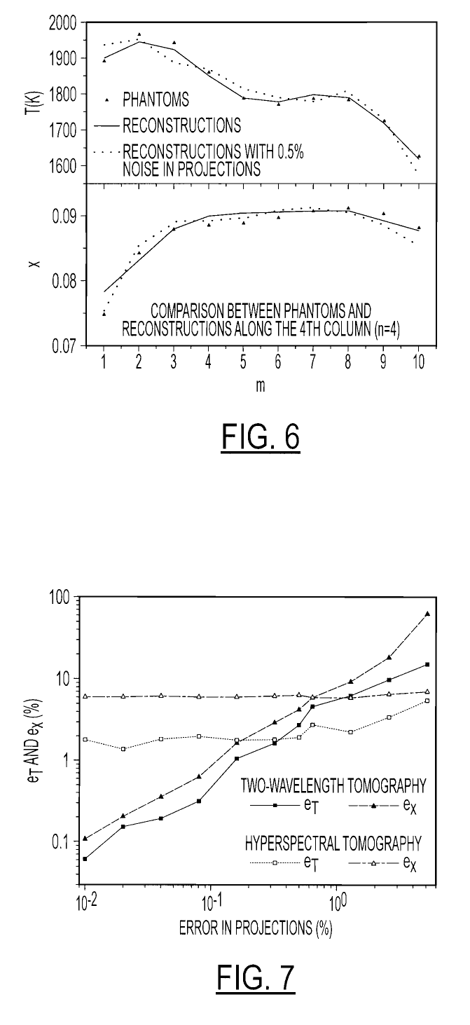

Using the inversion method developed above, computations can be performed to simulate the performance of the above HT method for simultaneous retrieval of T and X distributions. The reconstructed T and X profiles are shown in FIGS. 5A and 5B. As can be seen, agreement is achieved between the reconstructions and the phantoms. The algorithm reconstructs the multiple peaks and accurate shape of the T and the X distributions. FIG. 6 provides a better visualization of the reconstructions by comparing the reconstructions and the phantoms along the fourth column of the grid (n=4) with and without uncertainties in the projections, wherein the reconstructions with 0.5% relative uncertainties in the projections correspond to an e_{T} of 1.92% and an e_{X} of 6.35%.

FIGS. 5C and 5D display the reconstruction errors defined as the difference between the reconstructions and the phantoms. Settings for FIGS. 5A-5D are the same as those specified with respect to FIG. 4 (i.e., the SA algorithm is terminated when the largest change in T value is less than 0.1 K, and a γ_{T} of 1×10⁻¹⁰ and γ_{X} of 1×10⁻²⁰ are used). The reconstructed T and X correspond to an e_{T} of 1.44% and an e_{X} of 4.87%, respectively. The error of the T reconstruction is within −78 and 75 K; and the error of the X reconstruction within ±0.01. These errors can be further reduced by decreasing the termination criteria of the SA algorithm (at an increased computational cost). More sophisticated variations of the SA algorithm can be adopted to achieve higher accuracy while saving the computational cost. For example, the SA technique utilizing a genetically controlled random search method such as the one described in I. G. Tsoulos, and I. E. Lagaris, “Genanneal: Genetically modified simulated annealing,” Comp. Phys. Comm. 174, 846-851 (2006), incorporated by reference herein, may reduce the computational cost by about tenfold when compared with the SA algorithm used here. Furthermore, as can be seen in FIGS. 5A-5D, the extreme error usually occurs at the edge and corner grids, and the overall reconstruction error is significantly smaller. An explanation for this is that the edge and corner grids are less constrained by the smoothness regularization than the central grids. Therefore, by increasing the weights of the corner and edge grid in the regularization, the error can be reduced. Moreover, in practice, information regarding the boundary condition, if available, can be incorporated into the regularization factor to improve the reconstruction quality of the edge and corner girds.

These results, when compared with previous tomographic techniques utilizing one or two wavelengths, clearly demonstrate the benefits of hyperspectral tomography. First, for example, the number of projection measurements can be significantly reduced due to the increased spectral information content. With a two-wavelength tomography scheme as described above, the number of projections required to reconstruct T and X over a 10 by 10 grid is on the order of 100. With the HT technique, T and X can be reconstructed with high fidelity with 20 projections, representing a fivefold reduction compared to the two-wavelength scheme. Such significant reduction of projections can create a significant advantage for the practical implementation of the tomographic technique in many applications. Second, due to the increased spectral information content, simultaneous T and X reconstructions are obtained. This advantage can be further extended to image other quantities of interest as well. A third advantage involves the sensitivity and stability of the tomographic inversion. With a two-wavelength scheme, the ratio of the absorption line strength can be used to determine temperature. However, for a given pair of transitions (i.e. fixed lower-state energies), this ratio responds sensitively to temperature only in a certain temperature range, beyond which the method becomes insensitive to temperature and measurement errors are magnified. With the HT technique, more transitions can be included to maintain a good sensitivity in a wide range of temperature, therefore, rendering the technique more stability with measurement errors present, as described below.

### Stability

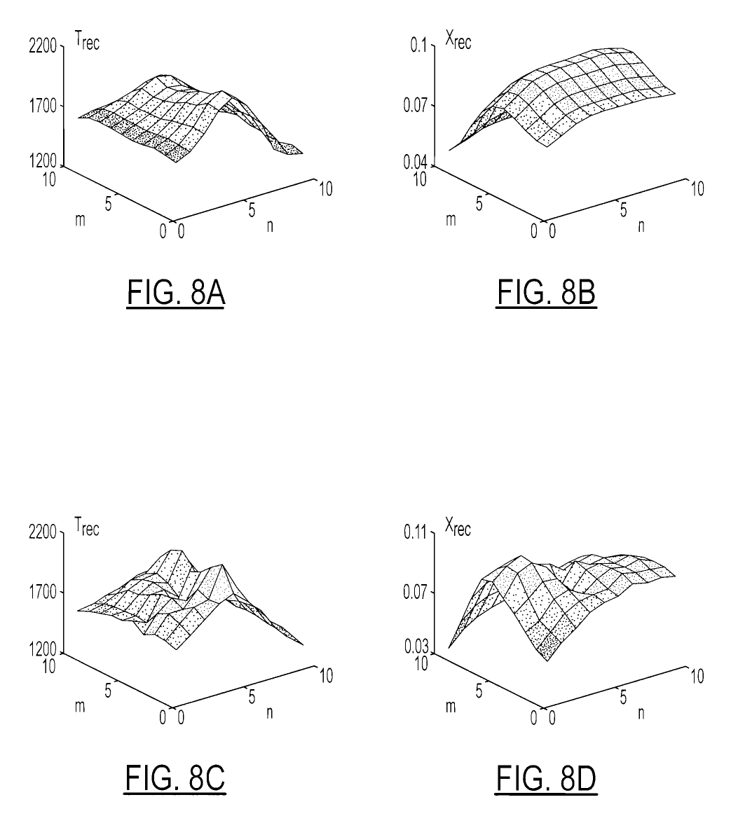

Simulations were performed to study the stability of the HT inversion technique when projection measurements contain noise. In these simulations, random noises were added into the projections (pₘ's) artificially; and the reconstruction of T and X was conducted with the noisy projection data. The results are summarized in FIG. 7 by showing the e_{T} and e_{X} of the reconstructions at different levels of noise addition. The noise level ranges from 0.01% to 5.12% relative to the projections, with 0.01% representing the situation where the projection measurements are subject to only the “fundamental” noises (i.e., shot noise, detector noise, digitization noise, etc.) and 5.12% representing the situation where the measurements are also subject to other larger noise sources (e.g. beamsteering, particulate scattering, window fouling, etc.). Five simulations were performed at each noise level; therefore, generating five e_{T}'s. The results shown in FIG. 7 are taken from that simulation that has the median e_{T}. As can be seen from FIG. 7, the HT technique of embodiments described herein yields T and X reconstructions quite insensitive to the noise. The e_{T} remains below 2% up to a noise level of 0.5%; and the e_{X} remains close to 6%. A visualization of the reconstructions from noisy projections (with a noise level of 0.5%) is shown in FIG. 6. Again, the reconstructions are compared with the phantoms along the fourth column of the gird. FIG. 6 shows that, though the deviation of the reconstructions from the phantoms becomes larger when compared with the case where there is no noise in the projection data, the reconstructions still capture the shape and magnitude of the phantoms quite accurately.

FIG. 7 also compares the stability of the HT technique of embodiments described herein to a two-wavelength tomography scheme. Here, the two-wavelength scheme consists of two wavelengths probing a pair of water vapor transitions, which are taken from X. Zhou, X. Liu, J. B. Jeffries, and R. K. Hanson, “Development of a sensor for temperature and water concentration in combustion gases using a single tunable diode laser,” Meas. Sc. & Tech. 14, 1459-1468 (2003), incorporated by reference herein, and their line strength ratio has a satisfactory temperature sensitivity in the temperature range of 1000 to 2000 K. A total of 100 projections were used in the two-wavelength scheme in this comparison. Therefore, at each wavelength, the integrated absorbance can be obtained by a direct matrix inversion method, a standard method known to one of ordinary skill in the art. Then, the distributions of the integrated absorbance at both wavelengths are combined to solve for temperature and concentration over each grid using the technique for uniform distributions. Here, the locations of the projections are designed such that the matrix has a condition number close to unity; therefore, noise in projections is not magnified enormously during the matrix inversion. In this sense, this simulation approximates the theoretical limit of the stability of two-wavelength tomography.

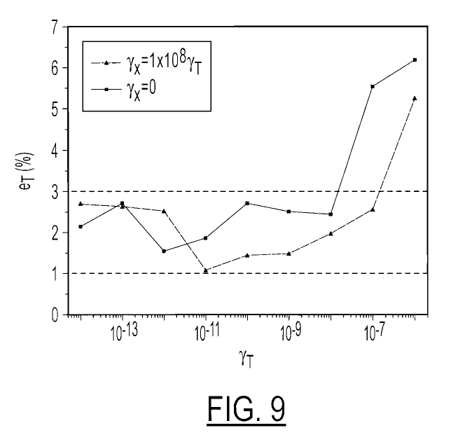

FIG. 7 shows that the e_{T} and e_{X} of the two-wavelength scheme indeed remain very low when the noise level is low, and the reconstruction fidelity is much better than that of the HT scheme. However, the e_{T} and e_{X} increase with the noise level, in contrast to the stable trend of e_{T} and e_{X} in the HT scheme. At noise levels exceeding 0.2%, the HT scheme of embodiments described herein begins to outperform the two-wavelength scheme in T reconstruction; and at noise levels larger than 0.5%, the HT scheme outperforms in both T and X reconstruction. FIGS. 8A-8D provide a comparison of reconstructions obtained using the HT and the two-wavelength scheme when the noise level in the projections is 0.5%. In particular, FIGS. 8A and 8B provide the reconstruction from the HT technique of embodiments described herein, while FIGS. 8C and 8D provide the reconstructions from the two-wavelength tomography scheme. As can been seen, the HT scheme of embodiments described herein reconstructed a more accurate T distribution than the two-wavelength scheme, and an X profile with about the same quality as the two-wavelength (also indicated by the same e_{X}'s at this noise level as shown in FIG. 7).

In summary, according to embodiments described herein, the HT technique can provide stable tomographic inversion over a wide range of noise levels. When compared with a two-wavelength tomography scheme, the HT technique of embodiments described herein can provide comparable or better performance when noise level exceeds 0.2% with a fivefold reduction in the number of projections.

### Optimal Regularization Parameters

As described above, tomographic reconstructions of temperature and concentration distributions can be obtained by minimizing Equation (7) where T^{rec} and X^{rec} denote the reconstructed temperature (T) and concentration (X) distributions, respectively; D the summation of the differences between the measured projections and the calculated projections at all locations and all wavelengths employed in the HT scheme; R_{T} and R_{X} the regularization factors derived from a priori information available; and γ_{T} and γ_{X} the regularization parameters to adjust the relative weights between the a posteriori knowledge (i.e., measured projections) and the a priori information (e.g. smoothness) in the tomographic inversion process. A hybrid algorithm can then be developed to minimize F and yield reconstructions of T and X.

Embodiments described herein provide methods to determine the optimal regularization parameters for HT. These methods, combined with the hybrid minimization algorithm, can provide for incorporation of hyperspectral information content in tomographic measurements.

As described above, the tomography problem based on hyperspectral absorption spectroscopy is nonlinear with respect to T, but linear with respect to X. Therefore, the tomographic inversion can be performed in two steps. In the first step, the T reconstruction can be retrieved by solving the nonlinear problem described in Equation (7), exploiting the fact the F responds much more sensitively to T than to X. In the second step, the X reconstruction can be retrieved as a regularized linear problem using the T obtained in the first step. Correspondingly, one method is developed for each step to determine the optimal regularization parameters. Described below are methods for determining regularization parameters in the first step and in the second step.

### Temperature Reconstruction

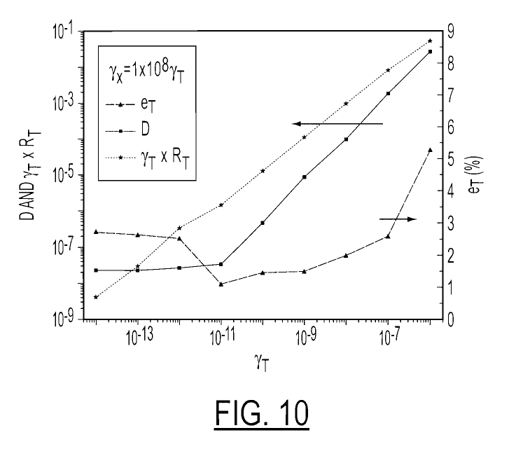

The function F, defined in Equation (7), is nonlinear with respect to T and linear with respect to X, resulting in a much more sensitive response with respect to T than to X. This characteristic of F allows the accurate retrieval of T reconstruction even though the reconstruction quality of X is low. Furthermore, this characteristic also results in the insensitivity of the T reconstruction with respect to the regularization parameters. The insensitivity of the T reconstruction with respect to γ_{T}, which is illustrated in FIG. 9, can be shown using Equations (9) and (10) above. As above, the domain of interest can be discretized by superimposing a square mesh of size M by N, and defining the normalized mean absolute distance measures of Equations (9) and (10) to quantify the quality of the reconstructions of T and X, respectively, where in Equations (9) and (10) T_{m,n}^{rec} and X_{m,n}^{rec} represent, respectively, the values of the reconstructed temperature and concentration distribution over the grid on the m^{th} row and the n^{th} column of the mesh; and T_{m,n} and X_{m,n} the values of the true distribution over the same grid.

The T reconstructions can be first performed with γ_{X}=1×10⁸γ_{T} (the scaling factors, 1×10⁸ is estimated from the magnitudes of the phantom T and X distributions), and the e_{T}'s obtained are displayed in FIG. 9, which illustrates the normalized mean absolute distance measure (e_{T}) of T reconstruction at different combinations of γ_{T} and γ_{X}. As shown in FIG. 9, a large γ_{T} (larger than ˜1×10⁻⁷ in this example) results in a large e_{T}. In this situation, the regularization factor, γ_{T}·R_{T} (T^{rec}), is exceedingly large; therefore, forcing the T^{rec} to be as smooth as possible, regardless of the projection measurements and resulting in a large reconstruction error. However, with a small γ_{T}, e_{T} remains low and stable within a wide range of γ_{T}. In this example, e_{T} varies within 1 to 3% for a γ_{T} spanning more than seven orders of magnitude, from 1×10⁻⁷ to 1×10⁻¹⁴. Second, the insensitivity of the T reconstruction with respect to γ_{X} is demonstrated. The T reconstructions were performed over a wide range of γ_{X}, and e_{T} and found to be insensitive to γ_{X}. As an example, FIG. 9 shows that the e_{T}'s obtained when there is no regularization on X at all (i.e. γ_{X}=0) behave very similar to the case when γ_{X}=1×10⁸γ_{T}.

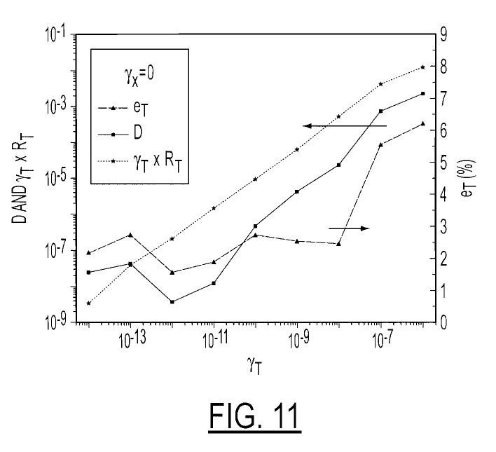

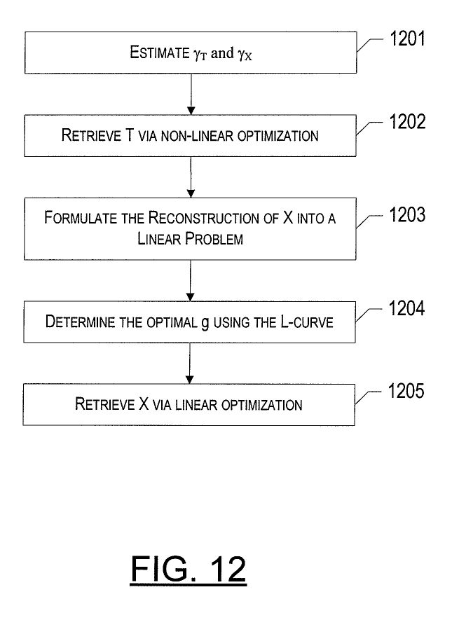

Based on the above discussion, γ_{T} can be chosen over a wide range with little influence on the reconstruction of T, and γ_{X} can be chosen almost arbitrarily. According to one embodiment, a good way to estimate γ_{T} is by comparing the contribution from the D term and the T regularization factor. FIGS. 10 and 11 compare these two contributions at various γ_{T}'s with γ_{X}=1×10⁸γ_{T} and γ_{X}=0, respectively. FIGS. 10 and 11 show the contribution of the T regularization factor decreases steadily with γ_{T} in both cases, since this contribution is directly proportional to γ_{T}. In contrast, the contribution from the D term does not decrease monotonically with γ_{T}. At certain values of γ_{T}, these two contributions are equal, which can be interpreted as an equal weight of the smoothness regularization and the measured projections. This condition provides a good way to estimate the optimal γ_{T}, as indicated by the low e_{T} in this range. Simulations performed at other values of γ_{X} result in the same observations and conclusions.

While the method described above provides a complete and practical method for determining the optimal γ_{T}, in practice, the “true” distribution is not known a priori, but the measured projections are available. Therefore, comparison of the D term and the T regularization factor is practically feasible by reconstruction using different γ_{T}'s; and the γ_{T} (denoted by γ_{T}*) that results in an equal contribution of the D term and the T regularization provides a good estimation of the optimal value of γ_{T}. Combined with the fact that the T reconstruction is not sensitive to the choice of γ_{T} over a wide range, γ_{T}* represents a close approximation of the optimal regularization parameter for the T reconstruction.

After the determination of the optimal regularization parameters for the T reconstruction, the T distribution can be retrieved by minimizing F, as described above. Retrieval of the T distribution completes the first step of the HT technique of embodiments described herein, and the retrieved T distribution is used in the second step to reconstruct the X distribution, which is described below.

### Concentration Reconstruction

With the T distribution obtained from the first step (denoted as T^{rec}), according to one embodiment, the HT problem becomes a linear problem and can be written in the matrix format as shown in Equation (8), above, where \vec{p}ₘ represents the measured projections organized to a column vector; \vec{X} the concentration values organized to a column vector; and \vec{S} the corresponding absorption strength matrix evaluated at the wavelengths used (denoted by X) using the T^{rec} obtained from the first step. Equation (8) can be solved in the least-squares sense to yield the X distribution. However, the \vec{S} matrix is often ill-conditioned and the solution of Equation (8) is, therefore, often compromised by small noise. A promising approach under investigation to ameliorate the ill-posedness of the \vec{S} matrix is to select the wavelengths such that \vec{S} has a large condition number.

The regularization technique can be used to overcome the ill-posedness of Equation (8), i.e., instead of solving Equation (8), the following minimization problem can be solved:

min ∥\vec{p}ₘ−\vec{S}(T^{rec},λ)·\vec{X}∥+g·∥\vec{H}·\vec{X}∥ (11)

where the ∥•∥ notation represents the Euclidean norm of a vector; \vec{H} an operator in matrix format corresponding to the regularization used on \vec{X}; and g the regularization parameter for the retrieval of \vec{X}. The utilization of such regularization techniques for the solution of ill-posed linear problems have been studied extensively, and several methods have been developed to determine the optimal regularization parameter. For example, in one instant the L-curve method described in P. C. Hansen, “Analysis of discrete ill-posed problems by means of the L-curve,” SIAM Rev. 34, 561-580 (1992), incorporated by reference herein, can be applied to determine the optimal regularization parameter for Equation (11) and to solve the concentration distribution.

The L-curve method involves solving Equation (11) at different values of g; and then calculating the residual, ∥\vec{p}ₘ−\vec{S}(T^{rec},λ)·\vec{X}∥, and the regularization factor, ∥\vec{H}·\vec{X}∥ at each value of g used. When the obtained residual is plotted versus the regularization factor, the curve exhibits a characteristic L-shape. The optimal regularization parameter can then be determined by locating the “corner” of the L-curve.

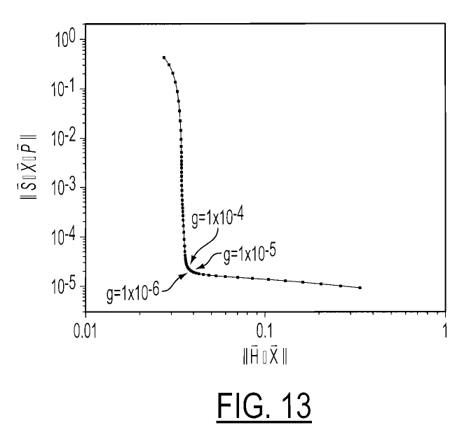

Before the application of the L-curve method to the reconstruction of X is described, the procedure to determine the optimal γ_{T} and γ_{X} in the described HT technique by the block diagram shown in FIG. 12 is summarized. The first step of the HT inversion can start with an estimation of γ_{T} and γ_{X} using the method described above (at Block 1201), and a retrieval of the T reconstruction (at Block 1202). The T reconstruction can then be used, at Block 1203, in the second step to compute the \vec{S} matrix and to formulate the X reconstruction into a regularized problem as described in Equation (11). After the determination of the optimal regularization parameter for the X reconstruction (g) (at Block 1204), reconstruction of X can be performed by solving Equation (11) (at Block 1205), completing the entire HT inversion in accordance with an embodiment described herein.

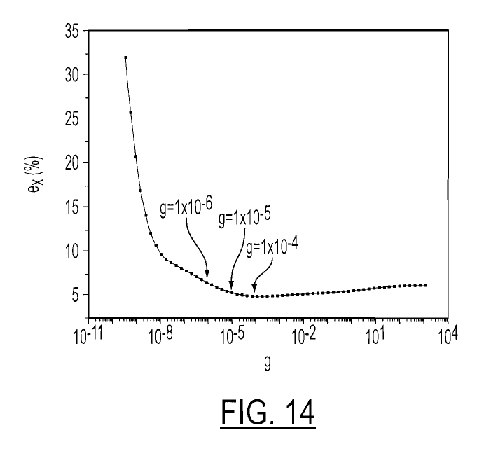

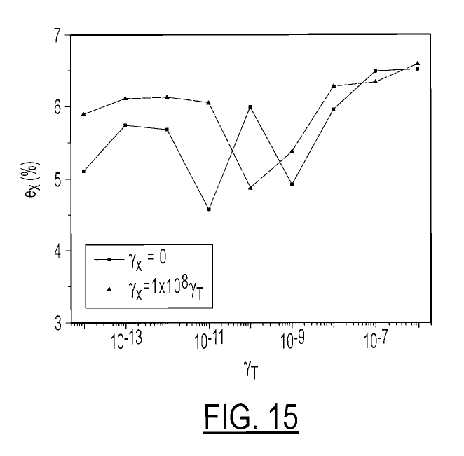

FIG. 13, which plots the residual versus the regularization factor with g ranging from 10⁻⁹ to 10³ shows a typical L-curve with a distinct “corner.” In this example, a γ_{T} of 1×10⁻¹⁰ and a γ_{X} of 1×10⁻² are used in the first step to obtain a T^{rec}, which corresponds to an e_{T} of 1.44%. After the \vec{S} matrix is evaluated using the T^{rec} obtained, Equation (11) is solved for various values of g ranging from 10⁻⁹ to 10³. The range of g is determined by calculating the following quantity:

$${g}^{0} = \frac{Tr ( {\vec{S}}^{T} \cdot \vec{S} )}{Tr ( {\vec{H}}^{T} \cdot \vec{H} )} \qquad ( 12 )$$

where Tr is the trace of the matrix. A choice of g, according to Equation (12), tends to make the residual and the regularization factor have comparable magnitude. Then, a range centered at g⁰ is determined to vary g. As shown in FIG. 13, at each value of g, the residual and the regularization factor were calculated and plotted. FIG. 13 clearly shows that the plot of the residual versus the regularization factors exhibits an L-shaped curve with a distinct “corner,” which can be located by finding the maximum curvature of the curve. The corresponding values of g around the corner are labeled on the plot; and, as shown in FIG. 14, which plots the values of e_{X} at different values of g, these values of g indeed yield small e_{X}'s. In this example, the minimum e_{X} (4.87%) occurs at a g of ˜1×10⁻⁴, which is located very close to the corner of the L-curve. Therefore, by locating the corner of the L-curve, the optimal g can be determined and used to reconstruct X. As described above, this method can yield a stable and accurate reconstruction of X.

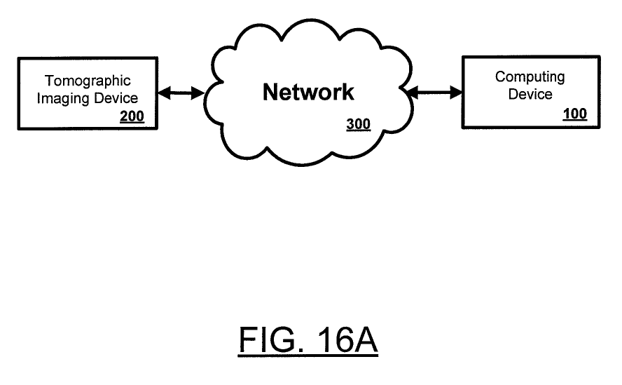

According to embodiments described herein, the reconstruction of X is insensitive to the initial estimation γ_{T} and γ_{X} in the first step. FIG. 15 shows the e_{X}'s obtained when different combinations of γ_{T} and γ_{X} are used in the first step. As can be seen, the values of e_{X} varies within 2% with γ_{T} and γ_{X} spanning wide ranges.

Based on the foregoing, embodiments described herein provide an effective method to determine the optimal regularization parameters in the nonlinear HT technique. The method of embodiments can obtain temperature and concentration reconstructions in two separate steps. In the first step, the optimal regularization parameter for the temperature reconstruction can be determined in advance with the measured projections, eliminating the need for adaptive adjustment during the inversion. In the second step, the optimal regularization parameter for concentration reconstruction can be determined using the L-curve method. This method of determining the optimal regularization parameters has been tested using numerical simulations and excellent performance has been demonstrated. The method of embodiments described herein, combined with the minimization method described previously, can provide a robust algorithm for HT, which can create significant advantages for expanded practical usage when compared with traditional tomography techniques based on one or two wavelengths.

### Computer System and Software

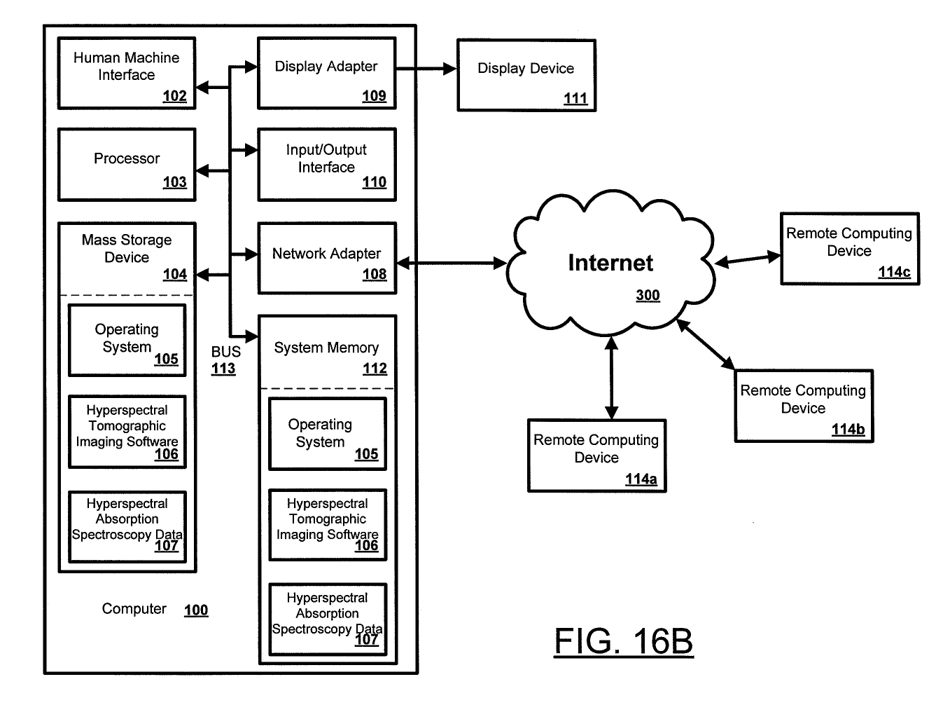

Reference is now made to FIG. 16A, which provides one example of a system in which embodiments described herein may be used. As shown, the system may include one or more tomographic imaging devices (also referred to as tomographs) 200 in communication with a computing device 100 over a wired or wireless communication network 300, such as a wired or wireless local area network (LAN), personal area network (PAN), wide area network (WAN), and/or the like. According to embodiments described herein, the tomographic imaging devices 200 and the computing device 100 may operate in conjunction with one another in order to perform tomographic imaging of one or more properties (e.g., temperature, concentration, etc.) of a substance (e.g., a gas) using hyperspectral absorption spectroscopy.

In particular, according to one embodiment, the tomographic imaging devices 200, which may each be located at a different location with respect to the substance (e.g., at different locations with respect to a combustion engine), may be configured to simultaneously capture an absorption measurement of the substance at three or more wavelengths. The tomographic imaging devices 200 may be configured to then communicate the absorption measurements to the computing device 100 via the network 200, such that the computing device 100 can create a tomographic image of one or more properties (e.g., temperature, concentration, etc.) of the substance.

In particular, reference is made to FIG. 16B, which provides a block diagram of a computing device 100 configured to create a tomographic image of one or more properties of a substance based on hyperspectral absorption spectroscopy information obtained from the one or more tomographic imaging devices 200 in accordance with an embodiment described herein. As one of ordinary skill in the art will recognize in light of this disclosure, this computing device 100 is only an example of computing device that may be used in conjunction with the system of embodiments described herein and is not intended to suggest any limitation as to the scope of use or functionality of computing device architecture. Neither should the computing device 100 be interpreted as having any dependency or requirement relating to any one or combination of components illustrated in the exemplary computing device 100.

The methods and systems of embodiments described herein can be operational with numerous other general purpose or special purpose computing system environments or configurations. Examples of well known computing systems, environments, and/or configurations that can be suitable for use with the system and method of embodiments described herein comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

As shown, the components of the computing device 100 can comprise, but are not limited to, one or more processors or processing units 103, a system memory 112, and a system bus 113 that couples various system components including the processor 103 to the system memory 112. In the case of multiple processing units 103, the system can utilize parallel computing. According to one embodiment, the processors or processing units 103 may be configured to perform the process described herein for creating a tomographic image of one or more properties (e.g., temperature, concentration, etc.) of a substance (e.g., a gas) based on hyperspectral absorption spectroscopy information obtained by one or more tomographic imaging devices.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus also known as a Mezzanine bus. The bus 113, and all buses specified in this description can also be implemented over a wired or wireless network connection (which may or may not be the same wired or wireless communication network providing a connection between the computing device 100 and the tomographic imaging devices 200) and each of the subsystems, including the processor 103, a mass storage device 104, an operating system 105, hyperspectral tomographic imaging software 106, hyperspectral absorption spectroscopy data 107, a network adapter 108, system memory 112, an Input/Output Interface 110, a display adapter 109, a display device 111, and a human machine interface 102, can be contained within one or more remote computing devices 114a,b,c at physically separate locations, connected through buses of this form, in effect implementing a fully distributed system.

The computing device 100 can comprise a variety of computer readable media. Exemplary readable media can be any available media that is accessible by the computing device 100 and can comprise, for example and not meant to be limiting, both volatile and non-volatile media, removable and non-removable media. The system memory 112 can comprise computer readable media in the form of volatile memory, such as random access memory (RAM), and/or non-volatile memory, such as read only memory (ROM). The system memory 112 can contain data such as hyperspectral absorption spectroscopy data 107 (e.g., including the absorption measurements simultaneously captured by the tomographic imaging devices at multiple wavelengths) and/or program modules such as operating system 105 and hyperspectral tomographic imaging software 106 that are immediately accessible to and/or are presently operated on by the processing unit 103.

According to one embodiment, the hyperspectral tomographic imaging software may comprise computer program code for instructing the processor 103 to perform the steps described herein in association with creating a tomographic image of one or more properties (e.g., temperature, concentration, etc.) of a substance (e.g., a gas) based on the hyperspectral absorption spectroscopy data 107. In particular, the hyperspectral tomographic imaging software may comprise computer program code for instructing the processor 103 to perform a tomographic inversion process in order to exploit the hyperspectral absorption spectroscopy data 107. As described above, according to one embodiment, the tomographic inversion process may comprise formulating the hyperspectral absorption spectroscopy information into a tomographic problem, casting the tomographic problem into a minimization problem configured to minimize the difference between one or more computed projections (e.g., of the temperature and concentration distributions) and one or more measured projections (e.g., of the temperature and concentration distributions), and solving the minimization problem by an algorithm (e.g., a simulated annealing algorithm).

In another aspect, the computing device 100 can also comprise other removable/non-removable, volatile/non-volatile computer storage media. By way of example, FIG. 16B illustrates a mass storage device 104 which can provide non-volatile storage of computer code, computer readable instructions, data structures, program modules, and other data for the computing device 100. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and hyperspectral tomographic imaging software 106. Each of the operating system 105 and hyperspectral tomographic imaging software 106 (or some combination thereof) can comprise elements of the programming and the hyperspectral tomographic imaging software 106. Hyperspectral absorption spectroscopy data 107 can also be stored on the mass storage device 104. Hyperspectral absorption spectroscopy data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computing device 100 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 103 via a human machine interface 102 that is coupled to the system bus 113, but can be connected by other interface and bus structures, such as a parallel port, game port, an IEEE 1394 Port (also known as a Firewire port), a serial port, or a universal serial bus (USB).

In yet another aspect, a display device 111 can also be connected to the system bus 113 via an interface, such as a display adapter 109. According to one embodiment, the display device 111 may be configured to display the tomographic images created by the computing device 100 in conjunction with the one or more tomographic imaging devices 200. It is contemplated that the computing device 100 can have more than one display adapter 109 and the computing device 100 can have more than one display device 111. For example, a display device can be a monitor, an LCD (Liquid Crystal Display), or a projector. In addition to the display device 111, other output peripheral devices can comprise components such as speakers (not shown) and a printer (not shown) which can be connected to computing device 100 via Input/Output Interface 110. Any step and/or result of the methods can be output in any form to an output device,

The computing device 100 can operate in a networked environment using logical connections to one or more remote computing devices 114a,b,c. By way of example, a remote computing device can be a personal computer, portable computer, a server, a router, a network computer, a peer device or other common network node, and so on. Logical connections between the computing device 100 and a remote computing device 114a,b,c can be made via the same or different wired or wireless communication network 300 as that providing the connection between the computing device 100 and the one or more tomographic imaging devices 200. Such network connections can be through a network adapter 108. A network adapter 108 can be implemented in both wired and wireless environments. Such networking environments are conventional and commonplace in offices, enterprise-wide computer networks, intranets, and the Internet.

For purposes of illustration, application programs and other executable program components such as the operating system 105 are illustrated herein as discrete blocks, although it is recognized that such programs and components reside at various times in different storage components of the computing device 100, and are executed by the data processor(s) of the computer. An implementation of hyperspectral tomographic imaging software 106 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

### EXAMPLES

The examples provided herein are put forth so as to provide those of ordinary skill in the art with a complete disclosure and description of how the compounds, compositions, articles, devices and/or methods claimed herein are made and evaluated, and are intended to be purely exemplary and are not intended to limit the scope of the methods and systems. Efforts have been made to ensure accuracy with respect to numbers (e.g., amounts, temperature, etc.), but some errors and deviations should be accounted for. Unless indicated otherwise, parts are parts by weight, temperature is in K or is at ambient temperature, and pressure is at or above atmospheric pressure.

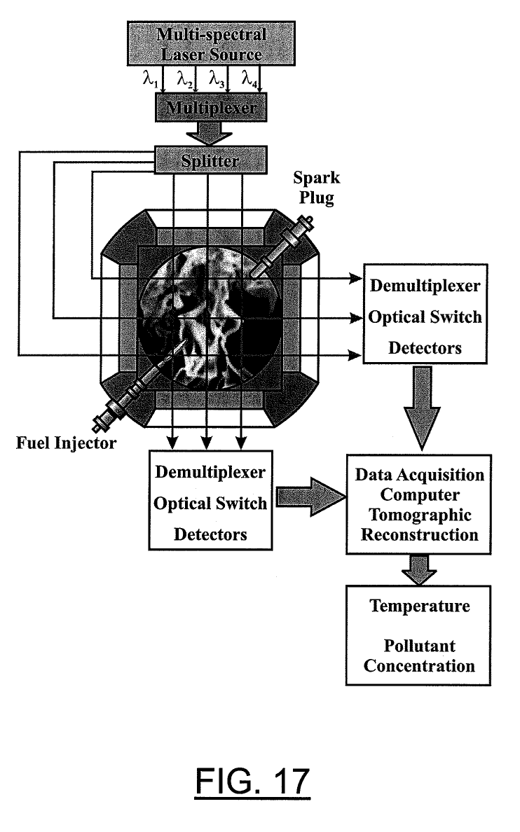

FIG. 17 illustrates an exemplary application of monitoring the operation (temperature and pollutant emission) of a combustion device, such as an engine or an incinerator using an embodiment of the systems and methods of tomographic imaging using hyperspectral absorption spectroscopy described herein. The information provided by the hyperspectral tomography technique can be used to improve the fuel efficiency and reduce the pollutant emission from the combustion device.

As shown in FIG. 17, in this example, a hyperspectral laser source is used to generate well-chosen wavelengths (shown as λ₁, λ₂, λ₃, λ₄), which are coupled into a single laser beam and split into different probing beams. Though four wavelengths are shown here, it is to be appreciated that more or fewer wavelengths are contemplated within the scope of embodiments of the invention. These probing beams are then used to perform absorption projection measurements of the target specie at different locations (six locations shown here though more or fewer locations are also contemplated within the scope of embodiments of the invention). Upon transmission from the region of interest, these probing beams are then demultiplexed to enable detection of absorption by individual detectors at each wavelength and each projection location. Finally, a data acquisition system digitizes the detected absorption signals, which are sent to a computer for tomographic reconstruction of the operation temperature and pollutant emissions of the combustion device.

Practically, the wavelength-multiplexing is quite straightforward by using for example fiber combiners; the wavelength-demultiplexing can be implemented by several commercial available devices as known to one of ordinary skill in the art. Furthermore, a commercial fast optical-switch recently made available (e.g. Thorlabs, Inc, FS702) can be used to reduce the number of detectors required by switching between different projection channels to the same detector. All methods provide good perspective for temporal resolutions (with easily realized time response of 2 milliseconds) and can be readily implemented.

As can be seen from the above description, this system extensively exploits recent advancements in hyperspectral measurement. Consequently, the easy implementation, low cost, and reliable and continuous measurement of the innovative technique of embodiments described herein makes it well-suited for expanded industrial use. The information provided by the hyperspectral tomography technique can be used to improve the fuel efficiency and reduce the pollutant emission from the combustion device.

The following describes yet another example in which the hyperspectral absorption techniques of embodiments described herein may be used in order to address combustion instability found in an aircraft engine. In particular, in chemically reacting flows, the instability modes that affect the performance of a combustor evolve both spatially and temporally. The presence of heat release due to the chemical reaction can complicate the spatiotemporally evolved Kelvin-Helmholtz instability generally associated with jet flows or mixing layers. The instabilities associated with the combustion and flow processes in turn can significantly affect the performance of the combustor or after burners. The two main instabilities associated with afterburners are low-frequency “rumble” and high-frequency “screech.” Rumble occurs mainly at high fuel-air ratios and at flight Mach numbers and altitudes where low duct inlet air temperatures and pressures exist and typically at 20-150 Hz. Augmentor screech is a high-energy acoustic tone generated by feedback loops. (See Powell, A., “On the Noise Emanating from a Two Dimensional Jet Above the Critical Pressure,” Aeronautical Quarterly, Vol. 4, February 1953, pp. 1030122; and Tam, C., Ahuja, K., Jones, R., “Screech Tones from Free and Ducted Supersonic Jets,” AIAA Journal, Vol. 32, No. 5, May 1994). Measurements from a single-point cannot reliably capture the events leading up to acoustic coupling in such spatiotemporally evolving flows. (See Broze, G. and Hussain, F., “Transitions to Chaos in a Forced Jet: Intermittency, Tangent Bifurcations and Hysteresis,” J. Fluid. Mech. 311, 37 (1996); Broze, G., Narayanan, S., and Hussain, F., “Measuring Spatial Coupling in Inhomogeneous Dynamical Systems,” Phys. Rev. E 55, 4179 (1997); and Roy, S. and Hussain, F. “Multisensor Analysis of Spatiotemporal Dynamics in Open Flows,” in Proceedings of the second International Seminar on Fluid Dynamics and Heat Transfer, BUET, Dhaka, Bangladesh, (1997)). Identifying and devising strategies for controlling the instability modes will require spatially and temporally resolved measurements of flame and flow parameters such as temperature, species concentration, or velocities. The number and locations of probes required to describe this dynamic system depend on the spatial extent of coupling and the domain size, both of which can change with various augmentor operating parameters and are not known a priori. Current state-of-the-art laser-based measurement technologies are incapable of providing both spatial and temporal resolution required to address the instabilities associated with combustors or after burners.

The technique of exploiting the hyperspectral information content of embodiments described herein is highly promising to enable such measurement capability to address the instability issues. The system of embodiments described herein extensively exploits recent advancements in hyperspectral measurement. Consequently, the easy implementation, low cost, and reliable and continuous measurement of the innovative technique of embodiments described herein also make it well-suited for expanded industrial use. The information provided by the hyperspectral tomography technique can be used to improve the fuel efficiency and reduce the pollutant emission from the combustion device.

### CONCLUSION

As described above and as will be appreciated by one skilled in the art, embodiments of the present invention may be configured as a system, method, or computing device. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 103 discussed above with reference to FIG. 16B, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 103 of FIG. 16B) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed:

1. A method comprising:
performing tomographic imaging of one or more properties of a substance using hyperspectral absorption spectroscopy.

2. The method of claim 1, wherein performing tomographic imaging further comprises:
simultaneously capturing, by one or more tomographic imaging devices, an absorption measurement of the substance at three or more wavelengths; and
using, by a computing device, the captured absorption measurements to create a tomographic image of the one or more properties of the substance.

3. The method of claim 2, wherein simultaneously capturing an absorption measurement further comprises:
simultaneously capturing, by the one or more tomographic imaging devices, an absorption measurement of the substance at three or more wavelengths at each of one or more locations associated with the substance.

4. The method of claim 2, wherein the one or more properties are selected from a group consisting of a temperature and a concentration of the substance.

5. The method of claim 4, wherein the substance comprises a gas.

6. The method of claim 4, wherein using the captured absorption measurements to create a tomographic image further comprises:
performing, by the computing device, a tomographic inversion process configured to exploit hyperspectral absorption spectroscopy information obtained from the absorption measurements captured.

7. The method of claim 6, wherein performing a tomographic inversion process further comprises:
formulating the hyperspectral absorption spectroscopy information into a tomographic problem;
casting the tomographic problem into a minimization problem configured to minimize a difference between one or more computed projections and one or more measured projections; and
solving the minimization problem by an algorithm.

8. The method of claim 7, wherein casting the tomographic problem into a minimization problem further comprises:
formulating the tomographic problem into the following minimization problem:
F(T^{rec},X^{rec})=D(T^{rec},X^{rec})+γ_{T}·R_{T}(T^{rec})+γ_{X}·R_{X}(X^{rec}),
where T^{rec} and X^{rec} denote reconstructed temperature (T) and concentration (X) distributions, D represents a summation of the differences between the one or more measured projections and the one or more computed projections performed at one or more locations and three or more wavelengths; R_{T} and R_{X} denote regularization factors derived from a priori information available; and γ_{T} and γ_{X} represent temperature and concentration regularization parameters, respectively, to adjust relative weights between a posteriori knowledge and the a priori information in the tomographic inversion process.

9. The method of claim 8, wherein solving the minimization problem further comprises solving the minimization problem using a simulated annealing algorithm.

10. The method of claim 9, wherein solving the minimization problem further comprises solving the minimization problem using a Levenberg-Marquardt method in combination with the simulated annealing algorithm.

11. The method of claim 8, wherein solving the minimization problem further comprises:
retrieving the reconstructed temperature distribution (T^{rec}) by solving the non-linear minimization problem; and
retrieving the reconstructed concentration distribution (X^{rec}) as a regularized linear problem using the retrieved reconstructed temperature distribution (T^{rec})

12. The method of claim 8, wherein solving the minimization problem further comprises:
determining an optimal temperature regularization parameter for the reconstructed temperature distribution based on the captured absorption measurements; and
determining an optimal concentration regularization parameter for the reconstructed concentration distribution using an L-curve method.

13. A system comprising:
one or more tomographic imaging devices configured to simultaneously capture an absorption measurement of a substance at three or more wavelengths;
a computing device in electronic communication with the one or more tomographic imaging devices, said computing device configured to receive the captured absorption measurements and to use the captured absorption measurements to create a tomographic image of one or more properties of the substance.

14. The system of claim 13, wherein respective tomographic imaging devices are positioned at a different location with respect to the substance, such that the one or more tomographic imaging devices are further configured to simultaneously capture an absorption measurement of the substance at three or more wavelengths at each of the one or more different locations.

15. The system of claim 13, wherein the one or more properties are selected from a group consisting of a temperature and a concentration of the substance.

16. The system of claim 15, wherein the substance comprises a gas.

17. The system of claim 15, wherein in order to use the captured absorption measurements to create a tomographic image, the computing device is further configured to:
perform a tomographic inversion process configured to exploit hyperspectral absorption spectroscopy information obtained from the absorption measurements captured.

18. The system of claim 17, wherein in order to perform a tomographic inversion process the computing device is further configured to:
formulate the hyperspectral absorption spectroscopy information into a tomographic problem;
cast the tomographic problem into a minimization problem configured to minimize a difference between one or more computed projections and one or more measured projections; and
solve the minimization problem by an algorithm.

19. The system of claim 18, wherein in order to cast the tomographic problem into a minimization problem the computing device is further configured to:
formulate the tomographic problem into the following minimization problem:
F(T^{rec},X^{rec})=D(T^{rec},X^{rec})+γ_{T}·R_{T}(T^{rec})+γ_{X}·R_{X}(X^{rec}),
where T^{rec} and X^{rec} denote reconstructed temperature (T) and concentration (X) distributions, D represents a summation of the differences between the one or more measured projections and the one or more computed projections performed at one or more locations and three or more wavelengths; R_{T} and R_{X} denote regularization factors derived from a priori information available; and γ_{T} and γ_{X} represent temperature and concentration regularization parameters, respectively, to adjust relative weights between a posteriori knowledge and the a priori information in the tomographic inversion process.

20. The system of claim 19, wherein in order to solve the minimization problem the computing device is further configured to solve the minimization problem using a simulated annealing algorithm.

21. The system of claim 20, wherein in order to solve the minimization problem the computing device is further configured to solve the minimization problem using a Levenberg-Marquardt method in combination with the simulated annealing algorithm.

22. The system of claim 19, wherein in order to solve the minimization problem the computing device is further configured to:
retrieve the reconstructed temperature distribution (T^{rec}) by solving the non-linear minimization problem; and
retrieve the reconstructed concentration distribution (X^{rec}) as a regularized linear problem using the retrieved reconstructed temperature distribution (T^{rec})

23. The system of claim 19, wherein in order to solve the minimization problem the computing device is further configured to:
determine an optimal temperature regularization parameter for the reconstructed temperature distribution based on the captured absorption measurements; and
determine an optimal concentration regularization parameter for the reconstructed concentration distribution using an L-curve method.

24. A computer program product comprising at least one computer-readable storage medium having computer-readable program code portions stored therein, said computer-readable program code portions comprising:
a first executable portion for performing tomographic imaging of one or more properties of a substance using hyperspectral absorption spectroscopy.

25. The computer program product of claim 24, wherein the first executable portion is configured to:
simultaneously capture, by one or more tomographic imaging devices, an absorption measurement of the substance at three or more wavelengths; and
use, by a computing device, the captured absorption measurements to create a tomographic image of the one or more properties of the substance.

26. The computer program product of claim 25, wherein simultaneously capturing an absorption measurement further comprises:
simultaneously capturing, by the one or more tomographic imaging devices, an absorption measurement of the substance at three or more wavelengths at each of one or more locations associated with the substance.

27. The computer program product of claim 25, wherein the one or more properties are selected from a group consisting of a temperature and a concentration of the substance.

28. The computer program product of claim 27, wherein the substance comprises a gas.

29. The computer program product of claim 27, wherein using the captured absorption measurements to create a tomographic image further comprises:
performing, by the computing device, a tomographic inversion process configured to exploit hyperspectral absorption spectroscopy information obtained from the absorption measurements captured.

30. The computer program product of claim 29, wherein performing a tomographic inversion process further comprises:
formulating the hyperspectral absorption spectroscopy information into a tomographic problem;
casting the tomographic problem into a minimization problem configured to minimize a difference between one or more computed projections and one or more measured projections; and
solving the minimization problem by an algorithm.

31. The computer program product of claim 30, wherein casting the tomographic problem into a minimization problem further comprises:
formulating the tomographic problem into the following minimization problem:
F(T^{rec},X^{rec})=D(T^{rec},X^{rec})+γ_{T}·R_{T}(T^{rec})+γ_{X}·R_{X}(X^{rec}),
where T^{rec} and X^{rec} denote reconstructed temperature (T) and concentration (X) distributions, D represents a summation of the differences between the one or more measured projections and the one or more computed projections performed at one or more locations and three or more wavelengths; R_{T} and R_{X} denote regularization factors derived from a priori information available; and γ_{T} and γ_{X} represent temperature and concentration regularization parameters, respectively, to adjust relative weights between a posteriori knowledge and the a priori information in the tomographic inversion process.

32. The computer program product of claim 31, wherein solving the minimization problem further comprises solving the minimization problem using a simulated annealing algorithm.

33. The computer program product of claim 32, wherein solving the minimization problem further comprises solving the minimization problem using a Levenberg-Marquardt method in combination with the simulated annealing algorithm.

34. The computer program product of claim 31, wherein solving the minimization problem further comprises:
retrieving the reconstructed temperature distribution (T^{rec}) by solving the non-linear minimization problem; and
retrieving the reconstructed concentration distribution (X^{rec}) as a regularized linear problem using the retrieved reconstructed temperature distribution (T^{rec})

35. The computer program product of claim 31, wherein solving the minimization problem further comprises:
determining an optimal temperature regularization parameter for the reconstructed temperature distribution based on the captured absorption measurements; and
determining an optimal concentration regularization parameter for the reconstructed concentration distribution using an L-curve method.
